(19) United States
(12) Patent Application Publication
(10) Pub. No.: US 2011/0161317 A1
(43) Pub. Date: Jun. 30, 2011

(54) DOCUMENT RETRIEVAL SYSTEM

(75) Inventor: Hiroshi Ohtani, Tokyo (JP)

(73) Assignee: FUJIFILM Corporation, Tokyo (JP)

(21) Appl. No.: 12/962,525

(22) Filed: Dec. 7, 2010

(30) Foreign Application Priority Data
Dec. 25, 2009 (JP) 2009-294580

(51) Int. Cl. G06F 17/30

(52) U.S. Cl. 707/728; 707/E17.014

(57) ABSTRACT

A document retrieval system includes a document server and mobile phones. A user may enter search criteria on a search criteria input screen of the mobile phone and transmit them to the document server through a certain network, e.g. the Internet. The document server retrieves documents according to the search criteria and refers to a search record database to determine whether the retrieved documents have ever been searched for and flagged with marks. The document server weights the respective documents on the basis of the marks tagged to the document or those elements that match the search criteria, and metadata included in the marks. Depending on the weight, the documents are listed in the order from the most relevant to or useful for the user when sent back as a search result to the mobile phone.

### BACKGROUND OF THE INVENTION

1. Field of the Invention

The present invention relates to a document retrieval system that allows retrieving desired documents, including text data and graphic data, from an intra-corporate server at a remote location in the field.

2. Description of the Related Art

“Google”, a registered trademark of the biggest Internet search engine, employs an algorithm named PageRank (a registered trademark of Google), which is well known as a tool for measuring importance or usefulness of Web pages. PageRank is primarily based on such concepts and perceptions that notable important Web pages tend to be linked from many other pages, that a Web page linked from some other important Web page is valuable, and that linkage from those pages which are provided merely for providing many linkages, like a links page, is less valuable.

In the case of searching for and retrieving some documents from a database within a company, on the other hand, the above mentioned PageRank algorithm cannot work because such an intra-corporate or in-house database does not include the concept of reference through the Web linkage. It is an important task to find a solution for facilitating retrieving useful documents from the intra-corporate database. Note that the documents contained in such an intra-corporate database may include office documents created in word-processing programs, graphs created in spread sheets, and drawings plotted using CAD software may be contained.

JPA2002-251410 discloses an information retrieval device, which detects operations done on a client computer during a search to evaluate usefulness of search results automatically on the basis of the detected operations, using a predetermined procedure of evaluation. The information retrieval device scores the usefulness of each search result that matches search criteria, and outputs the search results with information about their usefulness to the client computer, so that the search results are displayed in the order from the most useful.

JPA2002-108897 discloses an electronic sticky device, which allows users to display electronic sticky elements on an electronic document; the sticky may be a dedicated tag for exclusive use of each individual user, or a common tag indicating general information shared with other users. The former prior art suggests an idea of evaluating the usefulness of each search result automatically on the basis of operations done on the client computer.

Since there are a wide variety of possible operations done on the client computer, an advanced analyzing algorithm and high-speed hardware, including CPU and a storage device, are necessary for estimating the usefulness of the search results accurately based on the analysis of the operations done on the client computer. Thus, it seems very difficult to implement this idea in practice.

The latter prior art does not describe any association between the electronic sticky and the usefulness of the information tagged with the sticky. Although it may be presumed that the usefulness of tagged information is comparatively high, it is unobvious how a search for such an electronic sticky can provide useful results.

### SUMMARY OF THE INVENTION

In view of the foregoing, an object of the present invention is to provide a practically executable document retrieval system that facilitates retrieval of documents from a database within a particular company or organization even at a remote location in the field, enabling users to retrieve more useful documents from the database.

To achieve the above and other objects, the present invention provides a document retrieval system comprising a document server and a communication terminal. The document server has a document storage containing a plurality of documents, and retrieves, in response to a search request with search criteria, those documents from the document storage which includes at least an element that matches the search criteria, and transmitting the documents through a network. The communication terminal is used for inputting search criteria and transmitting the search request with the search criteria through the network to the document server. The communication terminal has a display device for displaying at least a fragment of each document received from the document server, the fragment including the element that matches the search criteria.

According to an aspect of the present invention, the communication terminal comprises a marking operation device operable by a user of the communication terminal to tag the document and/or the element with a mark that is specific to the user of the communication terminal; and the document server comprises a marking device and a weighting device. The marking device tags the mark to the document and/or the element in response to marking operation carried out through the marking operation device. The weighting device weights the usefulness of each document as retrieved from the document storage and containing the element that matches the search criteria of the search request from the communication terminal, on the basis of those marks which have already been tagged to the document. Thereby, the retrieved documents can be displayed on the display device in the order of most relevant to the user of the communication terminal first.

Preferably, the display device displays a list of the documents received from the document server, wherein the list shows at least a fragment of each document, including the element that matches the search criteria.

In a preferred embodiment, the mark has metadata containing at least information specific to the user of the communication terminal, and the document server further comprises a general user information storage that stores information about all users, as well as information about relations between individual users, between different groups of these users, and/or between the individual user and the respective groups. The relevancy evaluating device evaluates the relevancy of each of the documents retrieved from the document storage to the user of the communication terminal on the basis of the information about relations stored in the general user information storage and metadata of those marks which have been tagged to the document and/or the elements that match the search criteria of the search request. The weighting device weights the usefulness of each document on the basis of the relevancy of each document evaluated by the relevancy evaluating device such that the most relevant document appears on the top and the least relevant on the bottom of the list.

In another preferred embodiment, the communication terminal includes an user information storage storing information specific to a predetermined user of the communication terminal. The communication terminal also includes a document selection device operable by the user to select one of the documents from the list displayed on the display device, and a display controller that controls the display device to display one document selected by the document selection device in a substantially full screen size. A marking operation device of the communication terminal is operable by the user to tag a predetermined mark to the selected document and/or the element contained in the selected document displayed in the substantially full screen size. The mark has metadata containing at least the information specific to the user.

On the other hand, the document server includes a search record storage storing any search criteria that have ever been used for searching in the document retrieval system, IDs of those documents which have ever been retrieved, and any marks tagged to the stored documents and/or elements of the documents in association with each other, beside the marking device for tagging the mark to the document and/or the element and the general user information storage. On the basis of metadata of those marks which have been tagged to the documents retrieved from the document storage and/or the elements that match the search criteria of the search request, the marks being read from the search record storage, and the information about relations read from the general user information storage, the relevancy of each of the retrieved documents to the user of the communication terminal may be evaluated.

According to the document retrieval system of the present invention, search criteria are transmitted from a communication terminal, e.g. a mobile phone, through an appropriate network to a document server. The document server, which retrieves documents that match the search criteria, determines relevancy of each of the retrieved documents to the user of the communication terminal, to weight the value of the individual document according to the relevancy. Thus, the document server can provide the user with a search result such that the retrieved documents are listed in the order from the most relevant to the user first.

The document retrieval system of the present invention will make those documents accumulated within a certain corporation or organization available with easy to a member of the corporation or organization even while the member is in the field outside the corporation or organization. Moreover, since the search result shows the most relevant document to the user first on the list, the user can find useful documents for the user with ease. It should be noted that “usefulness” of a document refers to the value of the document for a user who retrieved this document, and is equivalent here to “relevancy” of the document to the user.

The document server may preferably include devices for statistically analyzing the relation between the search criteria and the marks tagged to the elements that match the search criteria, and creating a document showing a result derived from statistics. Thus, the document server may automatically compile statistics concerning individual search criteria and the marks and, according to the request, output statistical documents to the users. Accordingly, the users, e.g. corporate members, have only to mark the retrieved documents or related elements of the documents as a business routine, to collect statistics.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an explanatory diagram schematically illustrating a document retrieval system according to an embodiment of the present invention;

FIG. 2 is a block diagram illustrating an interior structure of a mobile phone;

FIG. 3 is a block diagram illustrating an interior structure of a document server;

FIG. 4 is a flowchart illustrating a main sequence of procedures of the document retrieval system;

FIG. 5 is an explanatory diagram illustrating an example of a search criteria input screen displayed on a display panel of the mobile phone;

FIG. 6 is an explanatory diagram illustrating an example of a search result displayed on the display panel of the mobile phone;

FIG. 7 is an explanatory diagram illustrating an example of a text of a document displayed on the display panel of the mobile phone;

FIGS. 8A, 8B and 8C are explanatory diagrams illustrating how a pie chart is produced from a statistical analysis of relation between a keyword and marks tagged to the keyword; and

FIG. 9 is a schematic diagram illustrating a bar graph produced from a statistical analysis of relation between a keyword and marks tagged to the keyword.

### DETAILED DESCRIPTION OF THE PREFERRED EMBODIMENTS

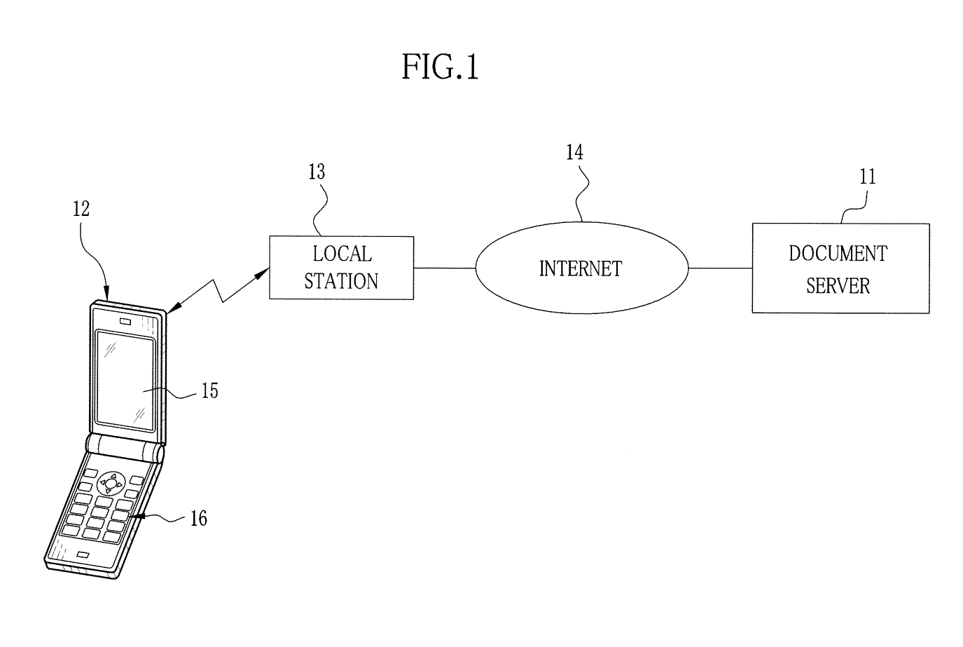

Referring to FIG. 1, a document retrieval system 10 of the present invention includes a document server 11 and communication terminals such as mobile phones 12. The mobile phones 12 are wirelessly communicable with base stations 13, through which the mobile phones 12 are accessible to a public network like the Internet 14, and are connectable to the document server 11 through the Internet 14. Thus, the document server 11 and the mobile phone 12 can communicate with each other through the Internet 14.

The document server 11 is an intra-corporate server for exclusive use by members of a particular corporation, such as a firm or any other kind of organization, and the document retrieval system 10 enables the corporate members, the users of the mobile phones 12, to access the document server 11 via the base station 13 and the Internet 14 while the users are in the field outside the organization. Then, the user can transmit search criteria such as a word, a phrase or a sentence to the document server 11, download useful documents for the user from the document server 11, and browse the documents on a display panel of the mobile phone 12.

In the present embodiment, documents may include electronic files created by the corporate members of the particular corporation, including copies of reference materials, electronic files created on Office applications such as word-processing programs, and electronic files stored in the PDF format. The contents of the documents include images and graphs as well as literal information or texts. Each document is tagged with a document ID as its own identification data.

The mobile phone 12 has a liquid crystal display (LCD) 15 and an operating section 16 consisting of cursor keys and alphanumeric keys. The mobile phone 12 has a function as a telephone, a function to send and receive e-mails, and a function for utilizing various services on the Internet. These functions are switchable through the operating section 16.

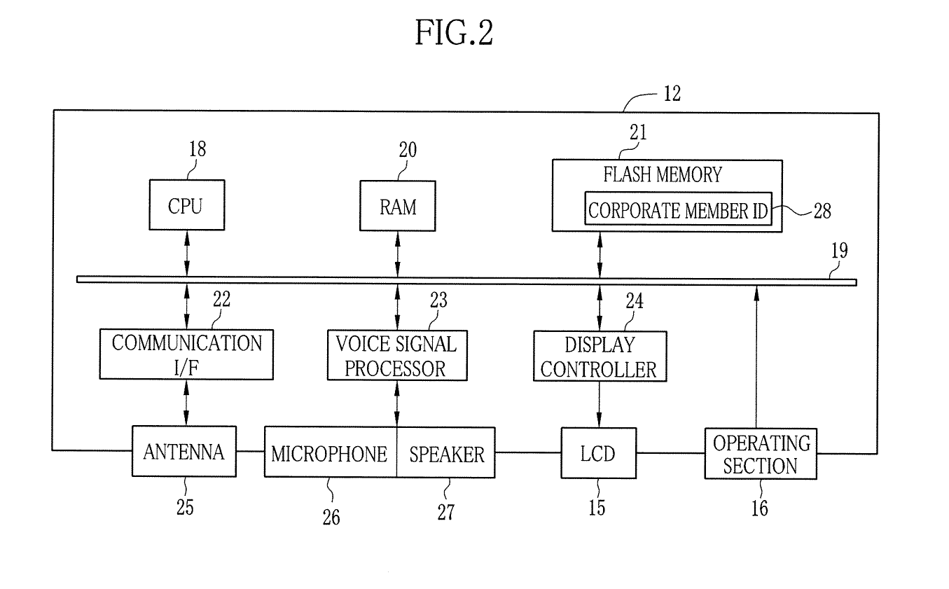

FIG. 2 shows the interior structure of the mobile phone 12. A CPU 18 comprehensively controls the overall operation of the mobile phone 12. Via a data bus 19, the CPU 18 is connected to the operating section 16, a RAM 20, a flashmemory 21 (an individual user information storage), a communication interface (I/F) 22, a voice signal processor 23, a display controller 24 and other components.

The flash memory 21 stores various programs and data for use in operation of the mobile phone 12. The CPU 18 reads the programs from the flash memory 21 and develops them on the RAM 20, to process the read programs sequentially. The flash memory 21 also stores identification data 28 of the respective users of the mobile phones 12, hereinafter referred to as corporate member IDs. The CPU 18 actuates the individual components of the mobile phone 12 according to operative input signals from the operating section 16.

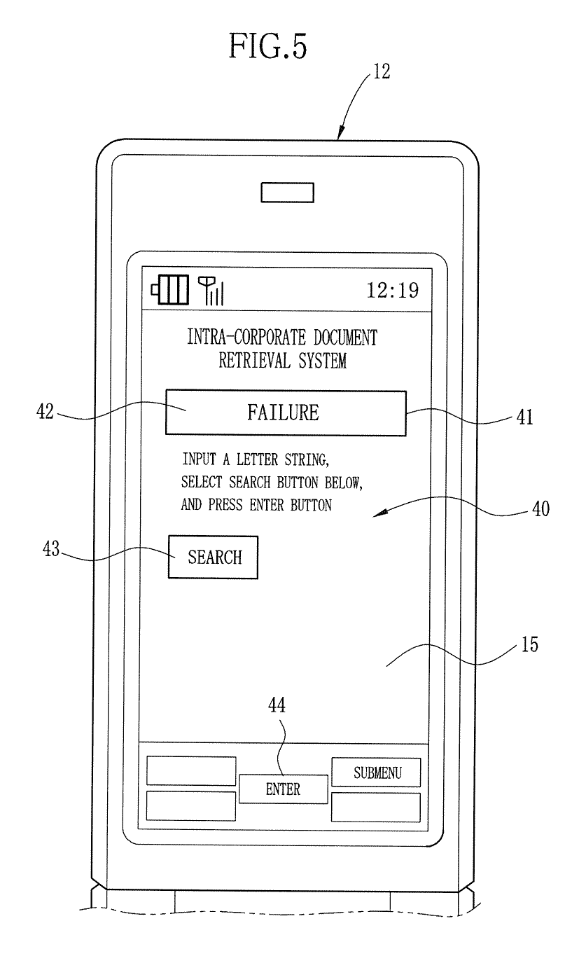

The communication interface 22 interfaces telephone and e-mail communications with other phones via an antenna 25, as well as data communications between the communication network like the Internet 14. The voice signal processor 23 converts voices or sounds entering through a microphone 26 to digital sound data. The sound data from the voice signal processor 23 of one mobile phone 12 is transmitted as electric waves through the communication interface 22 and the antenna 25 to the other phone. The digital sound data received as electric waves on the antenna 25 is converted through the communication interface 22 and the voice signal processor 23 to an analog sound signal, and is output to a speaker 27. The display controller 24 controls the LCD 15 to display an appropriate one of various screens, including a search screen 40 as shown in FIG. 5.

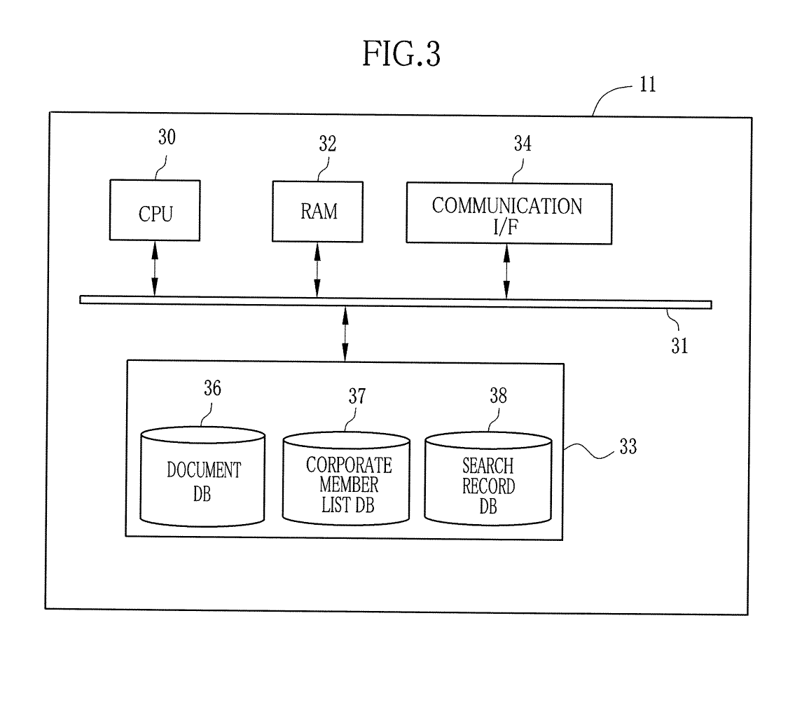

In FIG. 3 illustrating the interior structure of the document server 11, a CPU 30 comprehensively controls the overall operation of the document server 11. The CPU 30 is connected to a RAM 32, a hard disk drive (HDD) 33, a communication I/F 34 and other components via a data bus 31.

The CPU 30 reads the programs from the HDD 33 and develops them on the RAM 32, to process the read programs sequentially. The communication interface 34 interfaces data communications with the Internet 14 and other communication networks.

The HDD 33 stores various programs necessary for the operation of the document server 11, and also contains a document database (DB) 36, a member list database 37, and a search record database 38. The document database 36 is a document storage that stores an enormous volume of documents made and accumulated within the corporation. The member list database 37 is a general user information storage that stores private data of all corporate members, including the member IDs 28, sorted and compiled according to groups the corporate members belong to. The search record database 38 is a search record storage that stores information about past searches, including search criteria or keywords that have been used for searches, and IDs of those documents which have been retrieved using these search criteria, in association with each other.

Each document contained in the document database 36 has metadata appended thereto, including a member ID 28 of a corporate member who made the document, the date the document was made, marks such as asterisks that have been tagged to the document, and elements of the document, such as keywords or key phrases, that have been searched for. Individual documents in the document database 36 are respectively liked to corresponding member IDs in the member list database 37.

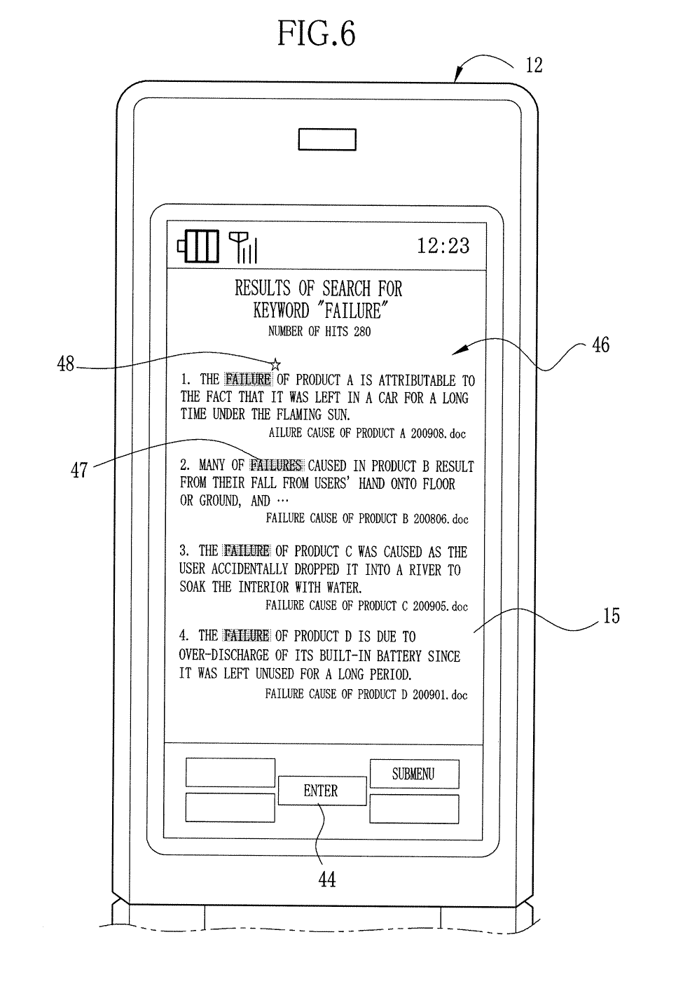

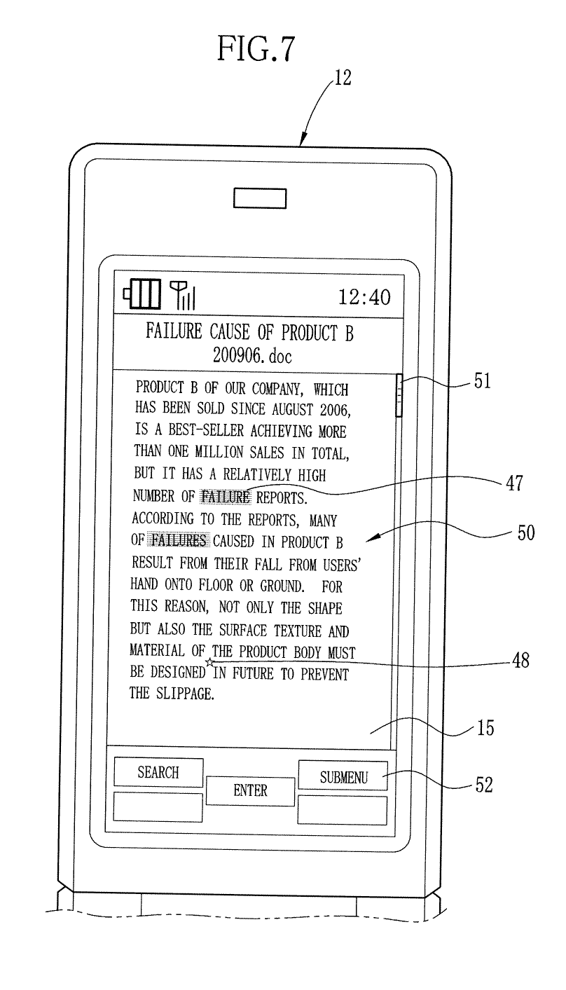

A corporate member may tag a document with a mark (see FIGS. 6 and 7) by operating the operating section 16, when the document retrieved from the document database 36 is desirable for the corporate member. The mark may be tagged to the document as the whole or to a searched element included in the document, that is an object of the search, e.g. the element “failure” 47 in FIGS. 6 and 7. In one embodiment, the user may put a mark to a document when the user determines that almost all contents of the document are important. On the other hand, when a fragment of a document corresponding to a searched element is important for the user, the user may put a mark to the searched element. The user may also mark a document and an element in the document as well. An individual user can tag the same document and/or the same element with multiple marks.

Each mark is accompanied by metadata that includes the location of the mark in a document, the member ID of a corporate member who applies the mark to the document, and the date and time of application of the mark. Those marks which are tagged to a document by other members than a corporate member who is browsing the document at present shall not principally be displayed. This is because some may refrain from adding a mark to a document or an element which another person, i.e. other corporate member (s) has already added a mark to, but it is desirable for the sake of evaluating the importance of a document by the number of marks added to the document that every member does not hesitate to mark the document or its element if they consider the document or the element important. Therefore, it is preferable making the mark visible only to the person who added that mark and invisible to others. It should be noted that the importance of each document is evaluated not only by the number of tagged marks but also the total weight value, as will be described in detail later.

Which element of a document is marked and how much the document is weighted depend upon the relation between the searching person who is conducting the search and persons who have ever marked the document. The document will be weighted the higher the closer the searching person is related to the person who marked the document. Specifically, the retrieved document is given the highest weight when the document was marked by the searching person oneself. The weight of the document gets lower in those cases where the document was marked by a person who belongs to the same group as the searching person, by a person whom the searching person is directly linked to, by a person who has a linkage with the searching person, and by other members, in this order of sequence. If several members have marked the same element or document, the usefulness of the element or document is determined based on the total of the number of tagged marks and the weight decided by the relevancy of the document to the searching person. Thus, such element or document that has been marked by the searching person and many other members who are in charge of those jobs related to the job of the searching person is judged to be more useful for the searching person. Consequently, the searching person can make full use of its own search records and other members' search records for the search.

The above “person whom the searching person is directly linked to” refers to a person whom the searching person has some relation to, such as a colleague, a member of another business department related to a business department of the searching person, or the like. The above “person who has a linkage with the searching person” also refers to a person who has some relation to the searching person, such as a subordinate or junior fellow of the searching person, or a member of another business department related to a business department of the searching person. The above “other members” refer to those members of the same corporation but have little business relation to the searching person.

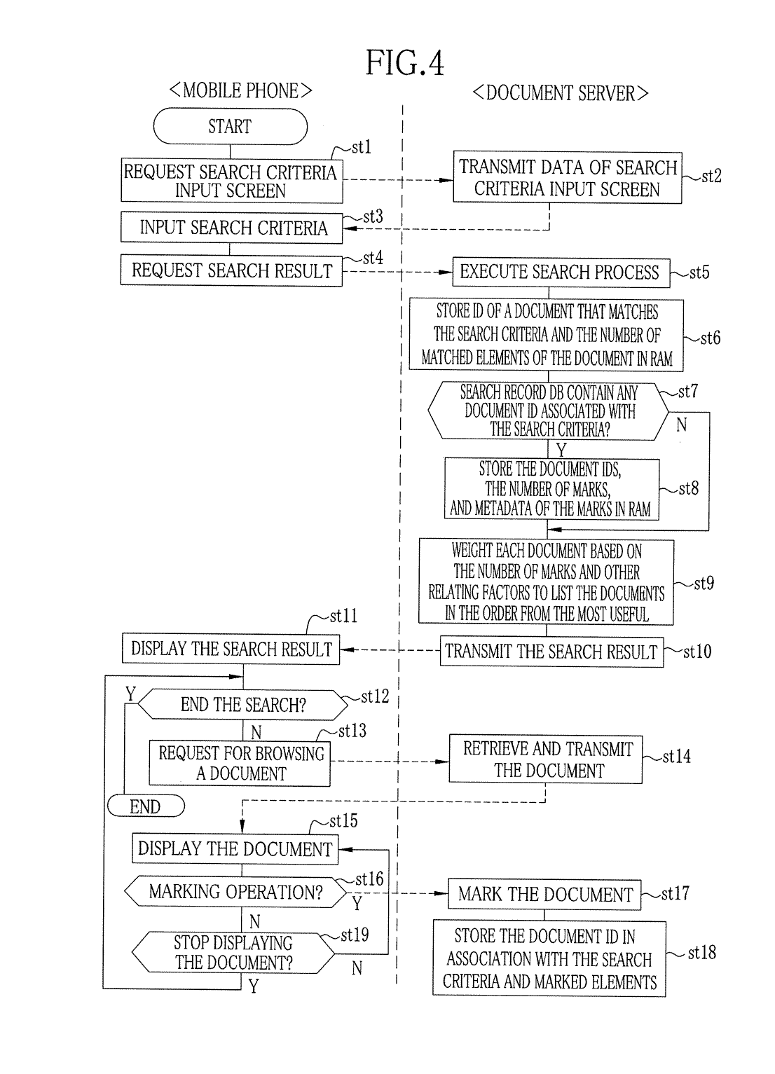

Now the operation of the document retrieval system 10 configured as above will be described with reference to the flowchart of FIG. 4 and FIGS. 5 to 7. In the following description, “st” in brackets stands for “step”, and steps st1 to st18 corresponds to steps illustrated in FIG. 4.

A corporate member-A can start a search for in-house documents in the field by operating the operating section 16 of a mobile phone 12, in which a member ID of this corporate member-A is registered, to request a search criteria input screen from the document server 11 (st1). When the document server 11 receives the request signal from the mobile phone 12 via the base station 13 and the Internet 14, the CPU 30 of the document server 11 reads out format data of the search criteria input screen from the HDD 33, and transmits the format data to the mobile phone 12 (st2).

Upon receipt of the format data of the search criteria input screen from the document server 11, the mobile phone 12 displays the search criteria input screen 40 on the LCD 15, as shown in FIG. 5. After inputting a keyword 42, e.g. “failure”, as a search criterion in an entry box 41 for search criteria on the search criteria input screen 40 (st3), a search button 43 is set to a selected status, and then a key of the operating section 16 that corresponds to an enter button 44 displayed in a bottom zone is operated to decide the input keyword for requesting a search result (st4).

When the document server 11 receives this request signal, the CPU 30 searches the document database 36 for those documents which match or include the keyword 42 (st5), and thereafter, IDs of the retrieved documents and the number of matched elements in each retrieved document are stored in the RAM 32 (st6).

Thereafter, the CPU 30 refers to the search record database 38 to check if the search record database 38 contains any document IDs that are associated with the same search criterion, i.e. the keyword “failure” 42 in the illustrated example (st7). If the search record database 38 contains a document ID associated with the same search criterion, marks tagged to the document and/or elements of the document, including metadata of the marks, and the number of these marks are stored in the RAM 32 (st8).

If the search record database 38 contains a document ID associated with the keyword 42, the CPU 30 operates as a relevancy evaluating and weighting device. That is, the CPU 30 determines how much the document is relevant to the member-A, i.e. the searching person, on the basis of the metadata of the marks, including the member ID, read from the RAM 32, the number of these marks, and the number of incidences of the element that matches the keyword 42 in the document. The CPU 30 weights the usefulness of each of the retrieved documents according to the relation of the document to the member-A, and list the retrieved documents in the order from the most useful (st9).

Thereafter, the CPU 30 extracts titles of the respective documents having the corresponding document IDs, and a short sentence including the incidences that match the keyword 42, for example, a couple of lines of each document, from the document database 36, and transmit the extracted data as a search result to the mobile phone 12 (st10). Thus, the mobile phone 12 displays the search result 46 on the LCD 15, as shown in FIG. 6 (st11). In the search result 46, the most relevant document to the member-A, such as one the member-A marked once, is displayed on the top of the retrieved documents.

Within the respective sentences displayed as the search result 46, the element “failure” 47 corresponding to the keyword is highlighted, as implied by hatching in the drawings. If this element 47 is one the member-A marked before, a predetermined mark, e.g. an asterisk 48 in the embodiment, is displayed beside the element 47. As described above, any marks put on the documents by other members are kept invisible to the member-A.

After browsing the search result 46 on the LCD 15, the member-A may end the search by operating the operating section 16 if he or she is content with the search result 46 and does not need to read the entire text of any document (st12).

From the search result 46, the member-A notices that he or she has ever browsed the first document displayed on the top of the screen, named “failure cause of product A 200908.doc”, because the mark 48 is displayed beside the element “failure” 47 in the first document, and no marks are visible except those added by the same person who is browsing the search result now.

If the member-A wishes to read the entire text of the second document “failure cause of product B 200906.doc” displayed next to the topmost document, the member-A selects the displayed short sentence of the second document by operating the operating section 16 (a document selection device) and press the key of the operating section 16, corresponding to the enter button 44. Then, a request for browsing the second document is transmitted to the document server 11 (st13). Although the preferred embodiments of the invention have been disclosed for illustrative purposes, those skilled in the art will appreciate that various modifications, additions and substitutions are possible, without departing from the scope and spirit of the invention as disclosed in the accompanying claims.

Responsive to the request for browsing from the mobile phone 12, the CPU 30 of the document server 11 refers to the document ID of the second document “failure cause of product B 200906. doc”, which is included in the request signal, to retrieve data of this document from the document database 36, and send the retrieved data back to the mobile phone 12 (st14).

When the mobile phone 12 receives the data of the second document, the CPU 18 controls the display controller 24 to display the entire text 50 of the document “failure cause of product B 200906.doc” in an substantially full screen size on the LCD 15, as shown in FIG. 7 (st15). Also in the text 50, the element “failure” 47 is highlighted, as implied by hatching in the drawing.

Because of the limited screen size of the LCD 15, only a fragment of the text 50 can be displayed at once on the LCD 15. With a vertical scroll bar 51, the user can scroll the text 50 to read the entire text 50.

If the member-A finds an element important for the member-A in the text 50, aside from the element “failure” 47, the member-A marks the element with an asterisk 48 (st16). The marking operating may be done by operating the operating section 16: selecting the element to be marked, pressing a key of the operating section 16 that corresponds to a submenu button 52 displayed on the LCD 15 to display a submenu, and executing a marking command (a marking device) provided in the submenu.

The marking command is transmitted from the mobile phone 12 to the document server 11. Then the CPU 30 functions as a marking device, flagging the corresponding document in the document database 36 with a mark 48 as metadata of the selected element (st17). With the document being marked this way, the mark 48 is displayed beside the selected element in the text of the document 50 on the LCD 15 of the mobile phone 12.

The CPU 30 stores the ID of the document 50, data of the search criteria (e.g. the keyword “failure”), data of the mark 48 including metadata such as the member ID of the searching person, which is read from the member list database 37, the number of marks 48, and data of the marked element or word if it differs from the keywords included in the search criteria, in association with each other in the search record database 38 (st18). After reading and marking the document 50, the member-A, the searching person, may stop displaying the document 50 by operating the operating section 16 (st19), and return the LCD 15 to the screen displaying the search result 46 (see FIG. 6).

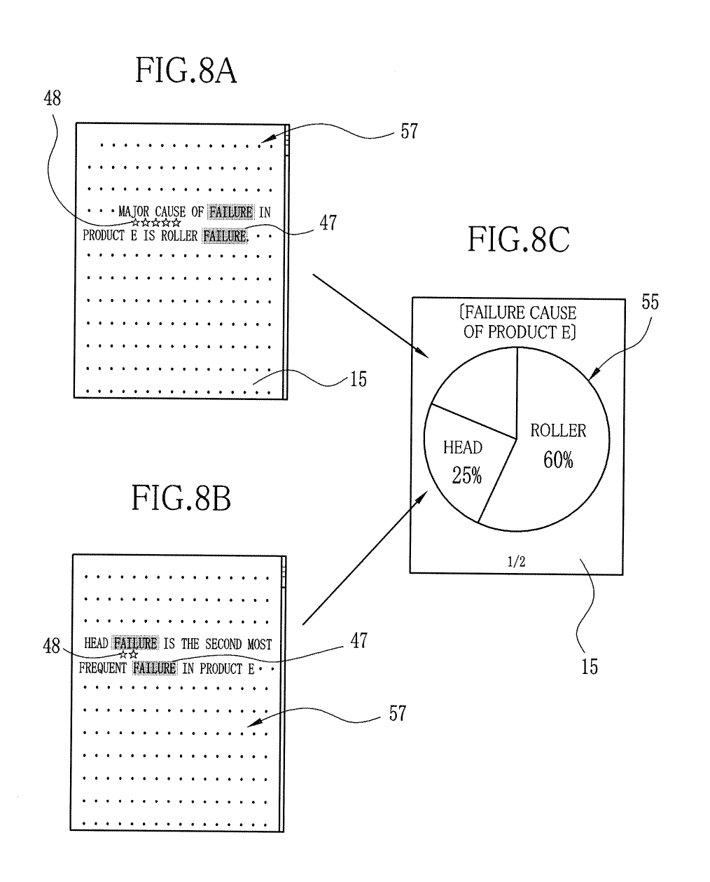

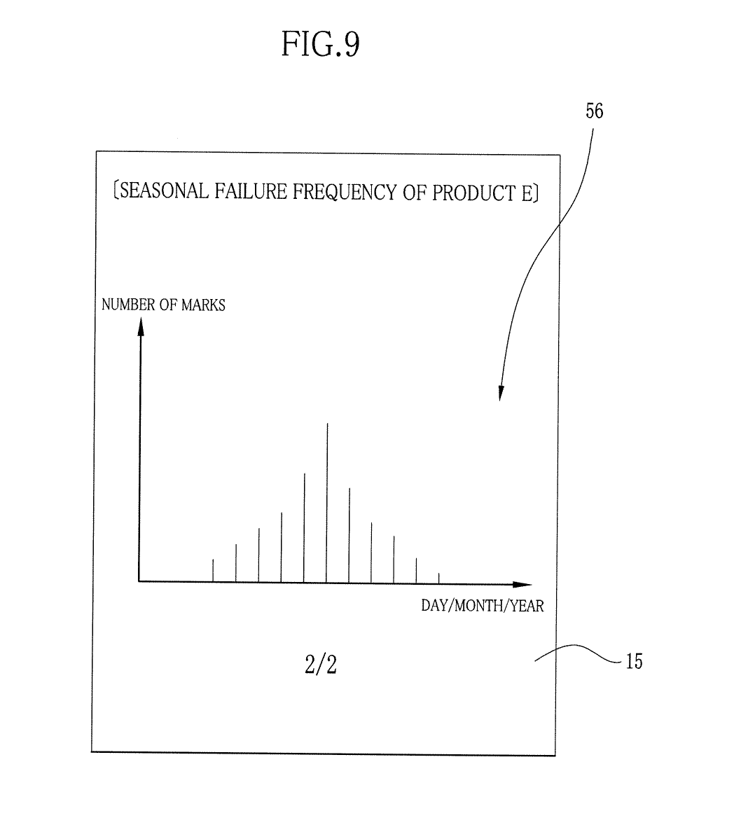

As described so far, each time a mark 48 is added, the search record database 38 stores the document ID, the search criteria, the mark, the marked element, and the number of marks in association with each other. On the basis of the data contained in the search record database 38, the CPU 30 can operate as a relation analyzing device and a document creating device when a request for displaying a document containing statistics, e.g. a failure record table about a particular product, is transmitted from the mobile phone 12 to the document server 11. Then, the CPU 30 automatically produces a pie chart 55 and/or a bar graph 56 as the failure record, as shown for example in FIGS. 8C and 9, and sends the data of the failure record to the mobile phone 12. Thus, the pie chart 55 or the bar graph 56 is displayed on the LCD 15 of the mobile phone 12.

Now the pie chart 55 will be described. In a text of a document 57 as shown in FIG. 8A, which is a report about failures caused in Product E, the number of marks 48 added to an element “failure” 47 of a word “roller failure” shows that “roller failure” is deemed to be the most frequent failure in the Product E. On the other hand, as shown in FIG. 8B, from the number of marks 48 added to an element “failure” 47 of a word “head failure” in the text of the document 57, “head failure” is deemed to be a relatively frequent failure in the Product E. A text analyzing program, such as Japanese language morphological analysis, is usable for measuring the frequencies of “roller failures” and “head failures” based the search result from the keyword “failure” 42. It should be noted that FIG. 8 shows all marks added to the element 47, including those added by other persons and actually invisible to the searching person, to make it easier to understand this process.

The CPU 30 statically analyzes the search record relating to the Product E, including the document 57 and other documents, to determine the respective percentages of “roller failures” and “head failures” to the total number of failures reported about the Product E, to create a pie chart, e.g. the pie chart 55 of FIG. 8C. The pie chart 55 apparently shows that “roller failures” account for 60% of all failures, and “head failures” 25%.

In case that the document 57 is a maintenance manual for a particular product, respective percentages of different kinds of failures of the product may be calculated by the analysis of the document 57 alone, because the maintenance manual is in one-to-one relation to the particular product.

Referring now to the bar graph 56 of FIG. 9, an axis of abscissa represents time, and an axis of ordinate represents the number of marks. For example, if the maintenance manual for the Product E is searched with the keyword “failure” 42, the number of marks tagged to the detected element 47 is determined. Since the metadata of the mark includes the date when the mark was tagged, it is possible to determine the number of marks tagged during a period of time. From the bar graph 56 showing time statistics on the number of tagged marks, the searching person can clearly know when a lot of troubles occurred in the Product E. The bar graph 57 may be created with respect to all failures occurred in a product, and/or with respect to a particular kind of failure or failure of a particular part, such as “roller failure” or “head failure”. Note that “failure” includes any trouble, fault, defect and breakdown in the description.

As described above, a statistical table, e.g. a failure record, is produced and revised automatically each time a member or user conducts a search for documents and flags some documents or some elements of the documents with marks. In response to a request for displaying a failure record, for example, the failure record may be displayed in the form of a user-friendly chart or graph on the LCD 15 of the mobile phone 12. Through the above-described marking operation, the user can report any trouble occurred in a product or its component and how the trouble was treated and register the data in the failure record while the user is searching for catalogs or the manual for this product, seeking to find the cause and solution of the trouble. Thus, the system according to the present invention will advantageously reduce the labor of the user. Conventionally, data cannot be efficiently input in a failure record unless the failure record is displayed on a relatively large scale monitor of a personal computer. On the contrary, the system according to the present invention will make it unnecessary for the users to input data in the failure record. The users have only to operate the mobile phones to retrieve necessary documents and make a report as well.

Note that, generally, in the case of searching a document or tagging a mark to a document, the users of the mobile phones access the document server via a wide area network, and in the case of storing a document, the users of the mobile phones access the document DB via a local net work.

Although the present invention has been described with reference to the above preferred embodiment, the present invention is not to be limited to the above embodiment. For example, the member ID of the member-A is previously memorized in the mobile phone 12 in the above embodiment, though the member ID may also be registered by the member-A through the operating section 16 of the mobile phone 12.

In the above embodiment, the marks are manually added by the user. In addition to the manual marking, the document server may mechanically mark an element in response to a search request for this element. In that case, the weight or value of such marks that are mechanically added should preferably be the lowest grade.

In the illustrated embodiment, particular elements of retrieved documents are flagged with marks. However, a document as the whole may be flagged with a mark.

In the above embodiment, metadata of each mark includes the location of the mark within the document, the member ID, and the date and time of application of the mark. The metadata may also include other data, such as a comment of the member who added the mark, in association with the member ID. In addition, the geometric location of a mobile terminal that is presently used for searching and marking an element may be included in the mark metadata, using GPS function of the mobile terminal. If metadata of a mark previously added to an element of a document includes data of the geometric location where this mark was tagged to the element, the element or the document containing this element may be weighted to take account of the relative location of a mobile terminal, which is presently used to retrieve the document, to the location indicated by the metadata of the previously added mark.

In the above embodiment, a couple of text lines are provided for each retrieved document in a search result. If, however, an abstract containing a searched element or keyword, e.g. a paragraph of 300 words or so, is appended to a retrieved document, the abstract may be provided instead.

In the above embodiment, search keywords are to be entered on the search criteria input screen. In another exemplary embodiment, a text of a document may be displayed fully on a display panel of a mobile terminal such that a word or sentence in the text is selectable to be sent as a search key to the document server. In that case, a graphic image, such as a picture, a portrait or a chart, may also be available as a search key, for example, by framing an area containing the graphic image and then pressing the search button. It should be understood that those skilled in the art will appreciate that various modifications, additions and substitutions are possible, without departing from the scope and spirit of the invention as disclosed in the accompanying claims.

What is claimed is:

1. A document retrieval system comprising:
a document server having a document storage containing a plurality of documents, said document server retrieving, in response to a search request with search criteria, those documents from said document storage which include at least an element that matches the search criteria, and transmitting the documents through a network; and
a communication terminal for inputting search criteria and transmitting the search request with the search criteria through said network to said document server, said communication terminal having a display device for displaying at least a fragment of each document received from said document server, said fragment including the element that matches the search criteria, wherein said communication terminal comprises a marking operation device operable by a user of said communication terminal to tag the document and/or the element with a mark that is specific to the user of said communication terminal; and
said document server comprises:
a marking device that tags the mark to the document and/or the element in response to marking operation carried out through said marking operation device; and
a weighting device that weights the usefulness of each document as retrieved from said document storage and containing the element that matches the search criteria of the search request from said communication terminal, on the basis of those marks which have already been tagged to the document such that the retrieved documents are displayed on said display device in the order of most relevant to the user of said communication terminal first.

2. A document retrieval system as recited in claim 1, wherein said document server further comprises:
a relation analyzing device that statistically analyzes relations between the search criteria and the marks; and
a document creating device that outputs a result derived from an analysis by said relation analyzing device as a document of a designated form.

3. A document retrieval system as recited in claim 1, wherein said document storage contains documents created within a corporation and available to members of said corporation.

4. A document retrieval system as recited in claim 3, wherein the member of said corporation is accessible to said document storage via a network.

5. A document retrieval system comprising:
a document server having a document storage containing a plurality of documents, said document server retrieving, in response to a search request with search criteria, those documents from said document storage which include at least an element that matches the search criteria, and transmitting the documents through a network; and
a communication terminal for inputting search criteria and transmitting a search request with the search criteria through a network to said document server, said communication terminal having a display device for displaying a list of the documents received from said document server, the list showing at least a fragment of each document, including the element that matches the search criteria, wherein
said communication terminal comprises an operation device operable by a designated user of said communication terminal to select one of the documents from the list and tag a predetermined mark to the selected document and/or the element contained in the selected document, the mark having metadata containing at least information specific to the user of said communication terminal, and said document server comprises:
a marking device that tags the mark to the document and/or the element in response to marking operation carried out through said operation device;
a general user information storage that stores information about all users, as well as information about relations between individual users, between different groups of these users, and/or between the individual user and the respective groups;
a relevancy evaluating device that evaluates the relevancy of each of the documents retrieved from said document storage to the user of said communication terminal on the basis of the information about relations stored in said general user information storage and metadata of those marks which have been tagged to the document and/or the elements that match the search criteria of the search request; and
a weighting device that weights the usefulness of each document on the basis of the relevancy of each document evaluated by said relevancy evaluating device such that the most relevant document appears on the top and the least relevant on the bottom of the list.

6. A document retrieval system as recited in claim 5, wherein said document server further comprises:
a relation analyzing device that statistically analyzes relations between search the criteria and the marks; and
a document creating device that outputs a result derived from an analysis by said relation analyzing device as a document of a designated form.

7. A document retrieval system comprising:
a document server having a document storage containing a plurality of documents, said document server, in response to a search request with search criteria, retrieving those documents from said document storage which include at least an element that matches the search criteria, and outputting the documents; and
a communication terminal for inputting search criteria and transmitting the search request with the search criteria through a network to said document server, said communication terminal having a display device for displaying a list of the documents received from said document server, the list showing at least a fragment of each document, including the element that match the search criteria, wherein
said communication terminal comprises:
an user information storage storing information specific to a predetermined user of said communication terminal;
a document selection device operable by the user to select one of the documents from the list displayed on said display device;
a display controller that controls said display device to display one document selected by said document selection device in a substantially full screen size; and
a marking operation device operable by the user to tag a predetermined mark to the selected document and/or the element contained in the selected document displayed in the substantially full screen size, the mark having metadata containing at least the information specific to the user, and
said document server comprises:
a marking device that tags the mark to the document and/or the element in response to marking operation carried out through said operation device;
a general user information storage that stores information about all users, as well as information about relations between individual users, between different groups of these users, and/or between the individual user and the respective groups;
a search record storage storing any search criteria that have ever been used for searching in said document retrieval system, IDs of those documents which have ever been retrieved, and any marks tagged to the stored documents and/or elements of the documents in association with each other;
a relevancy evaluating device that evaluates the relevancy of each of the retrieved documents to the user of said communication terminal on the basis of metadata of those marks which have been tagged to the documents retrieved from said document storage and/or the elements that match the search criteria of the search request, said marks being read from said search record storage, and the information about relations read from said general user information storage; and
a weighting device that weights the usefulness of each document on the basis of the relevancy of each document evaluated by said relevancy evaluating device such that the most relevant document appears on the top and the least relevant on the bottom of the list.

8. A document retrieval system as recited in claim 7, wherein said document server further comprises:
a relation analyzing device that statistically analyzes relations between the search criteria and the marks; and
a document creating device that outputs a result derived from an analysis by said relation analyzing device as a document of a designated form.
